(19) United States
(12) Patent Application Publication
(10) Pub. No.: US 2010/0053194 A1
(43) Pub. Date: Mar. 4, 2010

(54) DATA CREATING APPARATUS, DRAWING APPARATUS AND CONTROLLING METHODS THEREOF, AND RECORDING MEDIA

(76) Inventors: Yasuhisa NAKAMURA, Osaka (JP); Akio Kotani, Osaka (JP); Makoto Sakuta, Osaka (JP); Kayo Okamoto, Osaka (JP); Takayuki Nagamatsu, Osaka (JP)

Correspondence Address: BIRCH STEWART KOLASCH & BIRCH, PO BOX 747, FALLS CHURCH, VA, 22040-0747, US

(21) Appl. No.: 12/549,160

(22) Filed: Aug. 27, 2009

(30) Foreign Application Priority Data
Aug. 28, 2008 (JP) 2008-219755 (P)

(51) Int. Cl. G09G 5/02

(52) U.S. Cl. 345/589

(57) ABSTRACT

In a data creating apparatus, stored in a character information storing unit is information representing a basic portion of a graphic. A gradation information creating unit extracts oversampling information, and generates gradation data of a portion other than the basic portion of the graphic by an oversampling process.

This nonprovisional application is based on Japanese Patent Application No. 2008-219755 filed on Aug. 28, 2008 with the Japan Patent Office, the entire contents of which are hereby incorporated by reference.

### BACKGROUND OF THE INVENTION

1. Field of the Invention

The present invention relates to creating data for displaying an image, and particularly to creating gradation data.

2. Description of the Background Art

Conventionally, when gradation data of an image for each pixel is generated from an original image of a graphic or the like, the gradation data is created, for example, by pulse-surface-area modulation. The pulse-surface-area modulation is a method of setting a matrix including a plurality of dots and varying a pseudo-density depending on how many dots are placed in the matrix (see “Tech-On!”, [online], Nikkei Business Publications, Inc., [Retrieval on Aug. 25, 2008], the Internet (http://techon.nikkeibp.co.jp/article/WORD/20061215/125470/)). Generation of gradation data using pulse-surface-area modulation will be described with reference to FIG. 10.

With reference to FIG. 10, a pattern P1 shows pixels (4 pixels long×8 pixels wide) for which gradation data is generated. In pattern P1, a region constituting the outline of an original image is shown as a region X1.

When gradation data of each pixel is created using pulse-surface-area modulation, for example, a sub-pixel of 10×10 is defined for each pixel as shown as a pattern P2, and the number of sampling points of sub-pixels enclosed in the outline of the original image is counted for each pixel. Specifically, sub-pixels of a pixel at row 1, column 4, in pattern P1 are schematically shown on an enlarged scale in pattern P2. In order to create gradation data of each pixel, it is determined whether or not there is a sampling point for each of 100 sub-pixels of each pixel in a region constituting an outline (region X). In this way, the number of sub-pixels each having a sampling point inside the outline is counted for each pixel. The counted number is defined as a gradation value of each pixel.

In pattern P2, a sampling point of each sub-pixel is indicated by a dot at a central portion of each pixel. In pattern P2 of FIG. 10, 75 sampling points of those of 100 sub-pixels are positioned inside the outline (region X1). The gradation value of the pixel at row 1, column 4, in pattern P1 is therefore determined as 75%.

As described above, in conventional generation of gradation data, determination of whether or not a sampling position lies inside the outline has been needed for a large number of sub-pixels, such as 100 sub-pixels, for each pixel. Therefore, a disadvantage of requiring longer processing time has arisen.

### SUMMARY OF THE INVENTION

The present invention is conceived in view of such circumstances. An object of the invention is to shorten processing time required for generating gradation data.

A data creating apparatus of the present invention is a data creating apparatus for creating image data for displaying a graphic on a displaying device. The data creating apparatus includes a first storing unit storing information representing a basic portion of the graphic, a gradation generating unit for generating gradation data of a portion other than the basic portion of the graphic by an oversampling process, and a second storing unit for storing oversampling information that is information for performing the oversampling process. In the data creating apparatus, the gradation generating unit generates the gradation data based on the oversampling information extracted from the second storing unit.

A drawing apparatus of the present invention is a drawing apparatus for causing the displaying device to display the graphic based on the image data created by the foregoing data creating apparatus. The drawing apparatus includes a data mixing unit for generating data for displaying by mixing display data of a graphic display color and display data of a background display color based on the gradation data, and a sending unit for sending the data for displaying generated by the data mixing unit to the displaying device.

A method of controlling a data creating apparatus of the present invention is a method of controlling a data creating apparatus that includes first and second storing units and creates image data for displaying a graphic on a displaying device. The method includes the steps of causing the first storing unit to store information representing a basic portion of the graphic, causing the second storing unit to store oversampling information that is information for performing an oversampling process, extracting the oversampling information from the second storing unit, and generating gradation data of a portion other than the basic portion of the graphic based on the extracted oversampling information by the oversampling process.

A recording medium according to an aspect of the present invention records a program for causing a computer to execute the steps included in the foregoing method of controlling a data creating apparatus.

A method of controlling a drawing apparatus of the present invention is a method of controlling a drawing apparatus for causing the graphic to be displayed on the displaying device by sending the image data created by the foregoing data creating method to the displaying device. The method of controlling the drawing apparatus includes the steps of generating data for displaying by mixing display data of a graphic display color and display data of a background display color based on the gradation data, and sending the data for displaying to the displaying device.

A recording medium according to another aspect of the present invention records a program for causing a computer to execute the steps included in the foregoing method of controlling a drawing apparatus.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 schematically shows a hardware configuration of an information processing system that includes an information processing device serving as an embodiment of a data creating apparatus and a drawing apparatus of the present invention.

FIG. 2 is a control block diagram according to an embodiment of the data creating apparatus of the present invention.

FIGS. 3A and 3B schematically show one example of skeleton data used by the data creating apparatus of FIG. 2.

FIG. 4 is a flow chart of a gradation data generation process performed in the data creating apparatus of FIG. 2.

FIG. 5 is a view illustrating one example of an oversampling process performed in the gradation data generation process of FIG. 4.

FIG. 6 is a view illustrating another example of the oversampling process performed in the gradation data generation process of FIG. 4.

FIG. 7 is a flow chart of a modification of the gradation data generation process shown in FIG. 4.

FIG. 8 is a view illustrating merging of gradation data in the process shown in FIG. 7.

FIG. 9 is a flow chart of a gradation data creating process performed in the data creating apparatus of FIG. 2.

FIG. 10 is a view illustrating a conventional form of generation of gradation data using pulse-surface-area modulation.

### DESCRIPTION OF THE PREFERRED EMBODIMENT

An embodiment of a data creating apparatus and a drawing apparatus of the present invention will be described below with reference to the accompanying drawings. Note that, in the following description, the same components are denoted by the same reference characters in each drawing, and the detailed description on the components is not repeated if their names and functions are the same.

1. Configuration of Apparatuses

1-1. Hardware Configuration

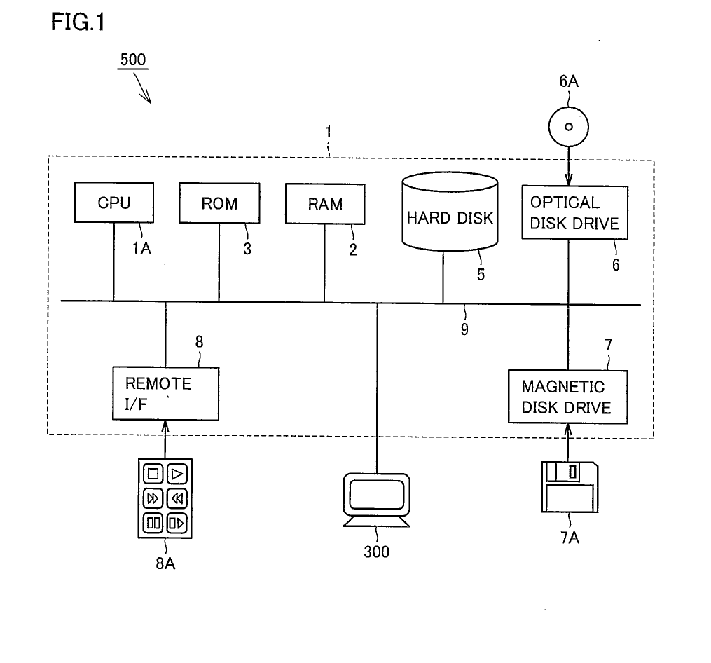

FIG. 1 schematically shows a hardware configuration of an information processing system that includes an information processing device serving as an embodiment of a data creating apparatus and a drawing apparatus of the present invention.

With reference to FIG. 1, an information processing system 500 mainly includes an information processing device 1 and a displaying device 300.

Information processing device 1 includes a CPU (Central Processing Unit) 1A for controlling the whole of information processing device 1, a RAM (Random Access Memory) 2 to be a work area of CPU 1A, a ROM (Read Only Memory) 3 for storing programs executed by CPU 1A, and the like, a hard disk 5, an optical disk drive 6, a magnetic disk drive 7, a remote (remote controller) 8A and a remote I/F (interface) 8. In information processing device 1, components are connected through a bus 9.

Optical disk drive 6 and magnetic disk drive 7 can read and/or write information from and/or to an optical disk 6A and a magnetic disk 7A, respectively. Optical disk 6A and magnetic disk 7A are removable from information processing device 1. A user can input information to information processing device 1 by operating remote 8A. Remote I/F 8 receives information sent from remote 8A and sends the received information to CPU 1A.

Information processing device 1 is connected to displaying device 300. CPU 1A outputs information to be displayed on displaying device 300 to displaying device 300. This allows displaying device 300 to perform displaying based on display data sent from information processing device 1.

1-2. Control Block Configuration of Data Creating Apparatus

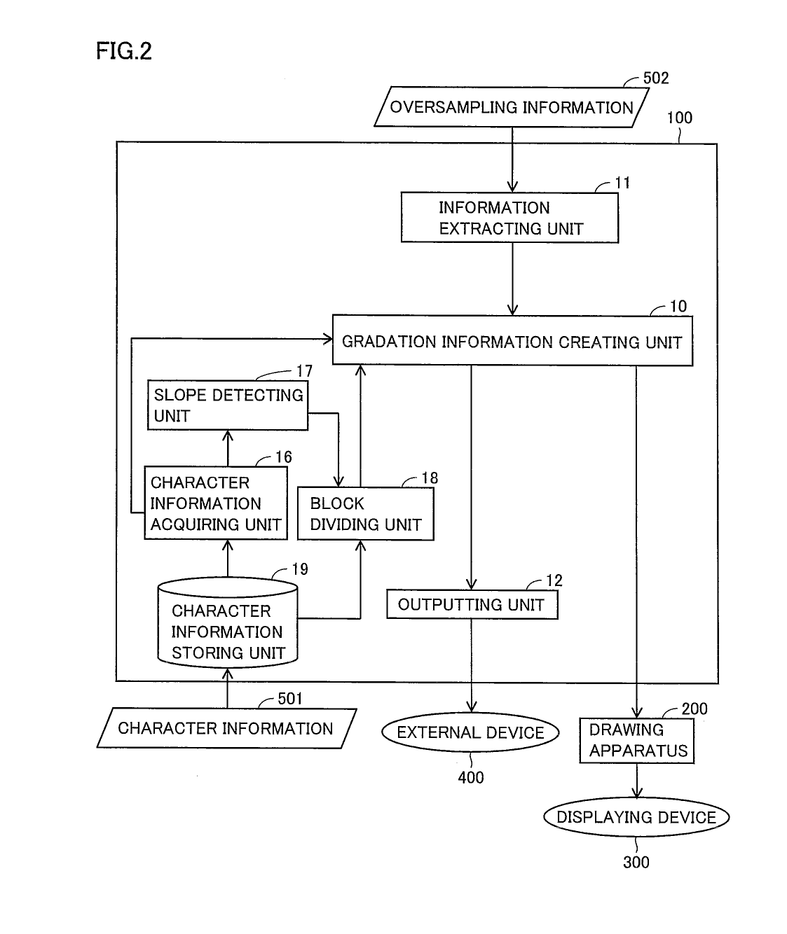

FIG. 2 is a control block diagram in the case where information processing device 1 functions as a data creating apparatus.

With reference to FIG. 2, in data creating apparatus 100, a gradation information creating unit 10 generates gradation data on a graphic such as a character or a symbol. When generating gradation data, gradation information creating unit 10 performs an oversampling process as an anti-aliasing process based on oversampling information 502.

Oversampling information 502 includes the number of sampling points for each pixel, the numbers of sub-pixels in the vertical and horizontal directions, and information specifying a sampling position in a sub-pixel when creating gradation data.

Oversampling information 502 is stored in ROM 3, RAM 2 or the like. If oversampling information 502 is stored in ROM 3, oversampling information 502 is predetermined information. Note that a user may input oversampling information by operating remote 8A or the like. The input oversampling information 502 is stored, for example, in RAM 2. Gradation information creating unit 10 acquires oversampling information 502 through an information extracting unit 11.

Gradation information creating unit 10 can also acquire character information 501 that is information specifying the kind of a graphic (a character, a symbol or the like) to be displayed on displaying device 300, and correct display data by using gradation information in accordance with character information 501. In data creating apparatus 100, character information 501 is stored in a character information storing unit 19. Gradation information creating unit 10 acquires character information 501 through a character information acquiring unit 16 when creating display data.

Note that, in data creating apparatus 100, it is possible to detect a slope of each portion in each graphic to be displayed on displaying device 300 and to divide the graphic into two or more blocks by using the detected slope. Gradation information creating unit 10 can generate gradation data for each block in gradation data of a graphic to be displayed on displaying device 300.

Gradation information creating unit 10 sends the generated gradation data through a drawing apparatus 200 to displaying device 300. Note that gradation information creating unit 10 can also send the gradation data through an outputting unit 12 to another device such as an external device 400.

As described above, data creating apparatus 100 described with reference to FIG. 2 is implemented with information processing device 1. Specifically, gradation information creating unit 10, information extracting unit 11, outputting unit 12, character information acquiring unit 16, a slope detecting unit 17 and a block dividing unit 18 are implemented with CPU 1A for executing programs stored on ROM 3 and/or hard disk 5 and the like. Character information storing unit 19 is implemented with RAM 2 and/or hard disk 5.

1-3. Drawing Apparatus

Drawing apparatus 200 illustrated in FIG. 2 mixes color data of a character color and color data of a background color on displaying device 300, based on gradation data of a graphic created in data creating apparatus 100, to generate image data of a portion other than a basic portion of the graphic. Drawing apparatus 200 combines image data of the basic portion of the graphic with image data of the portion other than the basic portion, and sends the combined data to displaying device 300.

Drawing apparatus 200 is implemented with CPU 1A for executing programs stored on ROM 3 and/or hard disk 5 and the like.

1-4. Information Representing Basic Portion of Graphic

In character information storing unit 19, skeleton data (one example of information representing a basic portion of a character or a symbol) for a graphic, such as a character or a symbol, to be displayed on displaying device 300 is stored in association with a code number provided to each character or symbol.

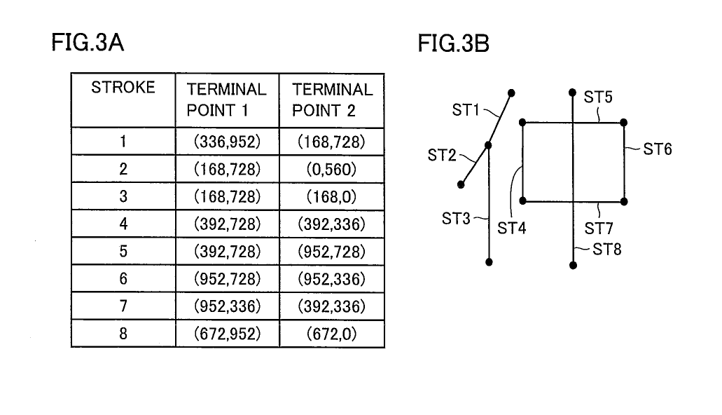

In the present embodiment, as the skeleton data, or one example of information representing basic portions, coordinates for specifying lines representing skeletons (skeleton lines), or one example of basic portions of each graphic, are stored as shown in FIG. 3A.

Shown in FIG. 3A is skeleton data of some Chinese character. Specifically, the skeleton lines of the Chinese character are made of eight strokes from ST1 to ST8 as shown in FIG. 3B. Coordinates that specify the starting point and the end point of each of strokes ST1 to ST 8 are stored as a terminal point 1 and a terminal point 2 in FIG. 3A.

Note that, in the present embodiment, information representing a basic portion of a graphic is not limited to skeleton data, and may be outline data. That is, assuming that outline data is basic portion data, for the outline data or data obtained by subjecting the outline data to an anti-aliasing process, data creating apparatus 100 can also correct gradation data of a portion near a basic portion in that data.

2. Generation of Gradation Data

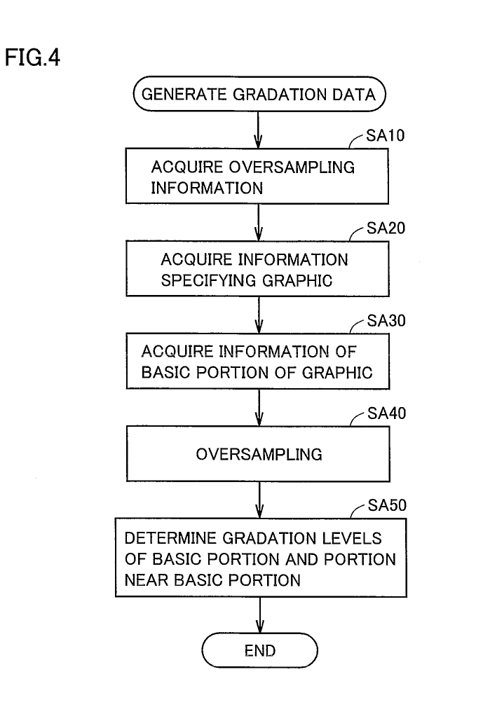

Next, a process that is performed when generating gradation data in data creating apparatus 100 will be described referring to FIG. 4, or a flow chart of the process.

Referring to FIG. 4, when an instruction for causing displaying device 300 to display a graphic, or the like is input, gradation information creating unit 10 first acquires oversampling information from RAM 2 or ROM 3 in step SA10, and the process proceeds to step SA20. Note that here, for example, a user is prompted to input oversampling information (the number of sub-pixels, and sampling positions and the number of sampling in sub-pixels), and the process may proceed to step SA20 on the condition that the information is input from the user.

In step SA20, gradation information creating unit 10 acquires information specifying a graphic to be displayed on displaying device 300 by extracting the information from an instruction content for displaying the graphic, or the like, and the process proceeds to step SA30.

In step SA30, gradation information creating unit 10 acquires information (e.g., skeleton data) specifying a basic portion of the graphic to be displayed on displaying device 300 through character information acquiring unit 16 from character information storing unit 19, and the process proceeds to step SA40.

In step SA40, oversampling is performed for the graphic for which the information specifying the basic portion has been acquired in step SA30, and the process proceeds to step SA50.

Note that the oversampling in step SA40 is performed based on the oversampling information acquired in step SA10.

FIG. 5 shows an example of the case where oversampling information indicates that the number of sub-pixels is 2×2, resulting in “4”, the number of sampling in each sub-pixel is “1”, and the sampling position in each sub-pixel is “center”.

FIG. 5 shows a state in which 9 sub-pixels are arranged in the vertical direction and 16 sub-pixels are arranged in the horizontal direction. Indicated by “.” at the center of each sub-pixel is a sampling position in each sub-pixel. Each pixel P constituting image data is equivalent to sub-pixels of two in the vertical direction and two in the horizontal direction.

In FIG. 5, sub-pixels with their sampling positions (sampling points) included in a region XA (skeleton portion) are shown to be colored. The colored sub-pixels as used here indicate that they are included in region XA, such as being included in the skeleton portion or being enclosed in the outline.

Thus, in the present embodiment, gradation data is generated using an oversampling mode, not pulse-surface-area modulation as conventionally used. Processing time can therefore be shortened when gradation data is generated.

Note that, in the oversampling process, if outline data is a subject of processing, the contour of a region indicated by region XA corresponds to the outline of the outline data.

Referring back to FIG. 4, as a result of the oversampling in step SA40, in step SA50, gradation information creating unit 10 determines gradation levels of a basic portion (a skeleton portion) and a portion near the basic portion of a graphic to be displayed on displaying device 300, generates gradation data for these portions, and stores the gradation data in RAM 2 or the like. Then, a gradation data generation process ends.

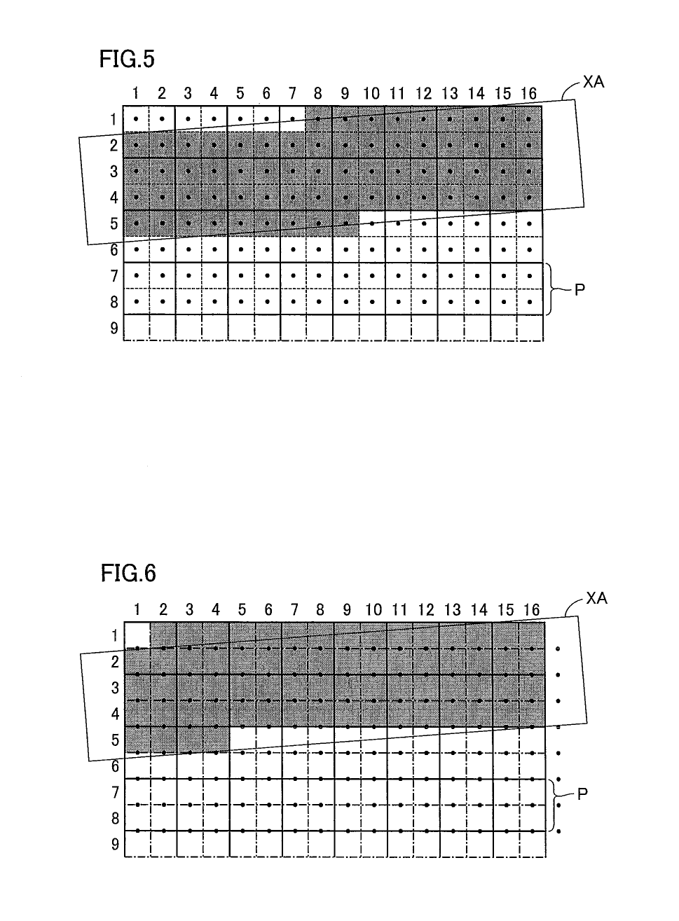

Note that, in the foregoing gradation data generation process, oversampling information is not limited to that mentioned above. For example, the sampling position may be in a lower end at the center in the lateral direction of each sub-pixel as shown in FIG. 6. In addition, the sampling position may be appropriately changed to be at the right lower corner, the left lower corner, the right upper corner or the left upper corner, or in an upper end at the center in the lateral direction, in a left end at the center in the vertical direction or in a right end at the center in the vertical direction of each sub-pixel.

3. Modification of Gradation Data Generation Process

In the present modification, an oversampling process is performed for each of a plurality of sampling positions regarding each sub-pixel, and the obtained gradation values of each pixel are added up, so that a gradation value of image data is determined.

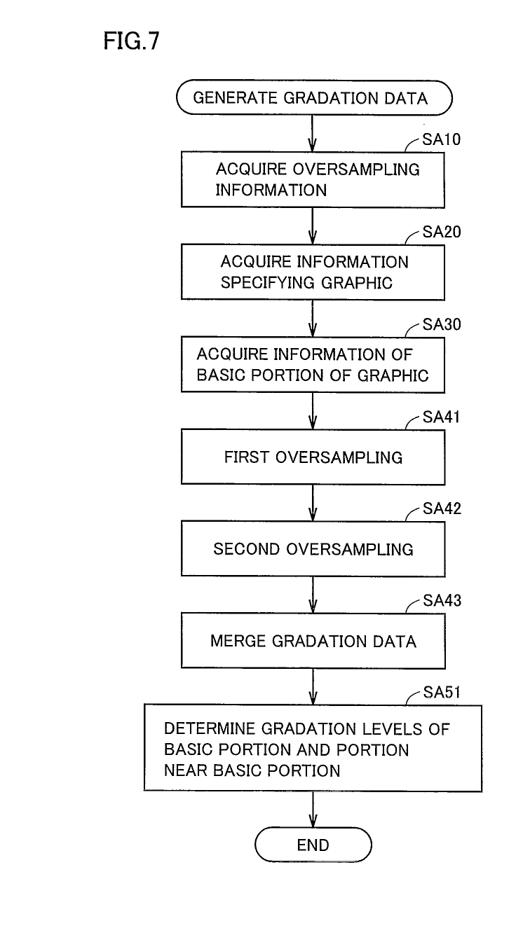

Referring to FIG. 7, in this modification, gradation information creating unit 10 acquires oversampling information in step SA10, acquires information specifying a graphic to be displayed on displaying device 300, in step SA20, and acquires skeleton data of the graphic in step SA30. Thereafter, the process proceeds to step SA41.

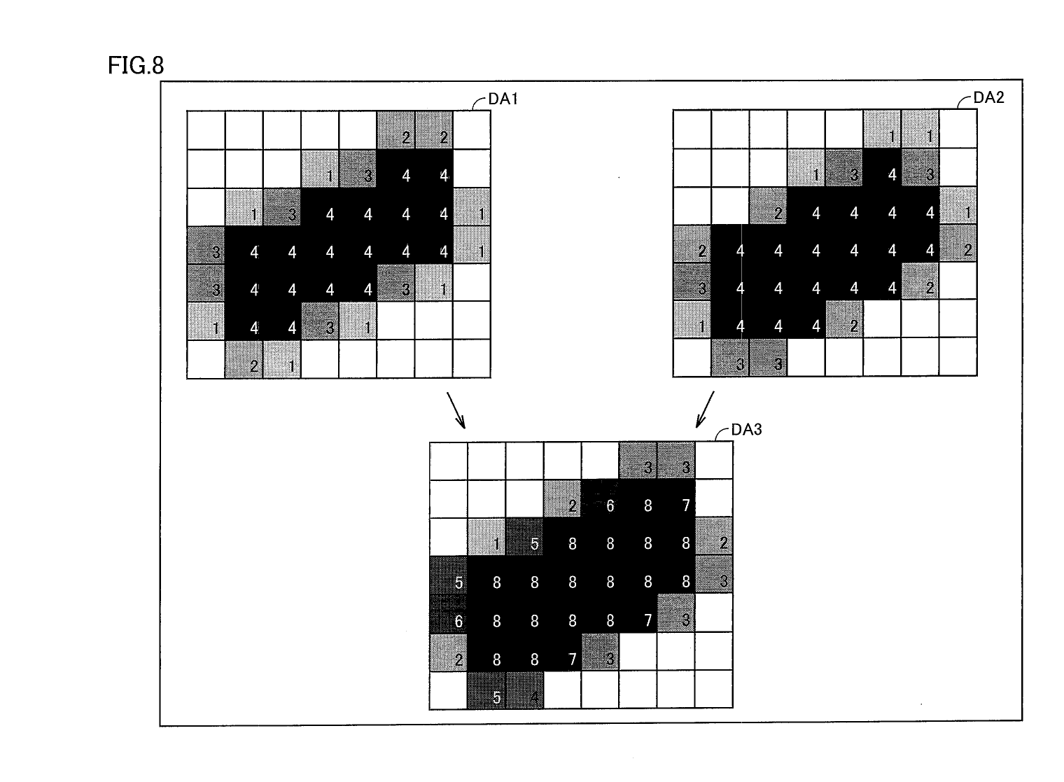

In step SA41, gradation information creating unit 10 performs an oversampling process while performing sampling at a first point (e.g., a central portion of each sub-pixel as shown in FIG. 5) to acquire a gradation value of each pixel. Next, in step SA42, gradation information creating unit 10 performs an oversampling process while performing sampling at a second point (e.g., a central portion in a lower end of each sub-pixel as shown in FIG. 6) to acquire a gradation value of each pixel. One example of gradation values of each pixel obtained by oversampling processes at two points is shown in data DA1 and data DA2 of FIG. 8. In data DA1 and data DA2, the gradation values are represented in five gradations from 0 to 4.

As understood from FIGS. 5 and 6, even with the same basic portion (outline data or skeleton data) of a graphic that is being processed, if the sampling positions of each sub-pixel are different, the same sub-pixel may be colored and may also not be colored. This can cause different gradation values of a pixel relevant to that sub-pixel.

As understood from data DAM and data DA2 of FIG. 8, even when a graphic that is being processed has the same skeleton data, a pixel at the same position can have different gradation values depending on the position of sampling for determining the presence of coloring of the sub-pixel concerned.

Note that, in data DA1 and data DA2 of FIG. 8, with each square corresponding to a pixel, image data in five gradations from 0 to 4 is schematically shown. Filled squares correspond to pixels each having the highest gradation value (gradation value 4). Regarding other pixels, in pixels having gradation values other than 0, gradation values are written in numbers.

Referring back to FIG. 7, after the oversampling process at the second point is finished in step SA42, gradation information creating unit 10 merges the gradation data obtained in step SA41 and the gradation data obtained in step SA42, in step SA43.

With reference to data DA3 of FIG. 8, merging of a plurality of pieces of gradation data will be described.

Data DA3 of FIG. 8 schematically shows gradation data generated by merging data DA1 and data DA2, which is performed by adding up gradation values of pixels corresponding to each other of data DA1 and data DA2, without being changed.

Data DA3 is gradation data in eight gradations because it is generated by adding up two pieces of gradation data in five gradations.

Note that, when a plurality of pieces of gradation data are merged, gradation values of pixels corresponding to one another in a plurality of pieces of data may be added up without being changed as described with reference to data DA1 to DA 3 of FIG. 8. The plurality of pieces of gradation data may also be merged by assigning weights to the gradation values of the corresponding pixels in a manner different from one another based on a condition, such as a sampling position, under which oversampling is performed, and thereafter adding up the gradation values.

In the example described with reference to FIG. 8, data DA1 and data DA2 are in five gradations, and data DA3 is in eight gradations. That is, as a result of merging of a plurality of pieces of gradation data, the number of gradations after merging is larger than the number of gradations before merging. If a plurality of pieces of gradation data are merged by setting an average value of gradation values of pixels corresponding to one another of the plurality of pieces of gradation data as the gradation value of each pixel of image data to be newly generated, such an increase of the number of gradations due to merging can be avoided.

4. Further Modification of Gradation Data Generation Process

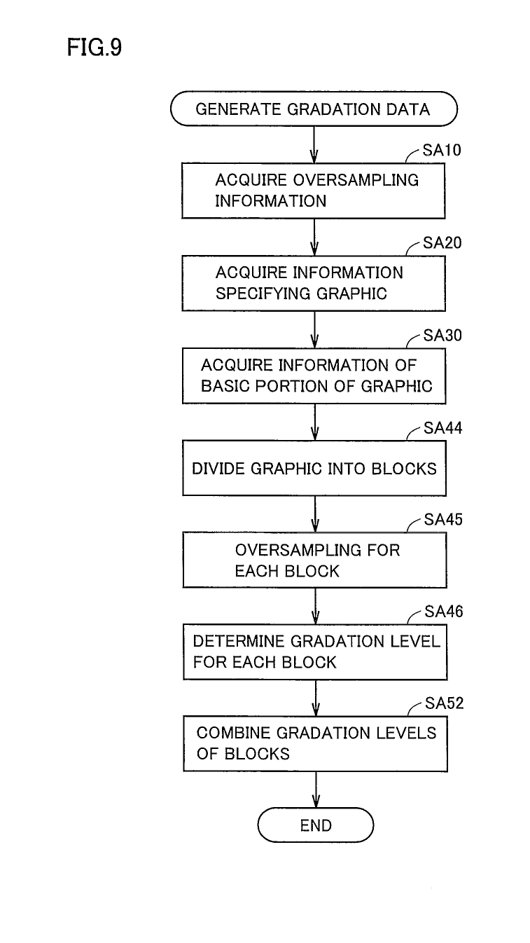

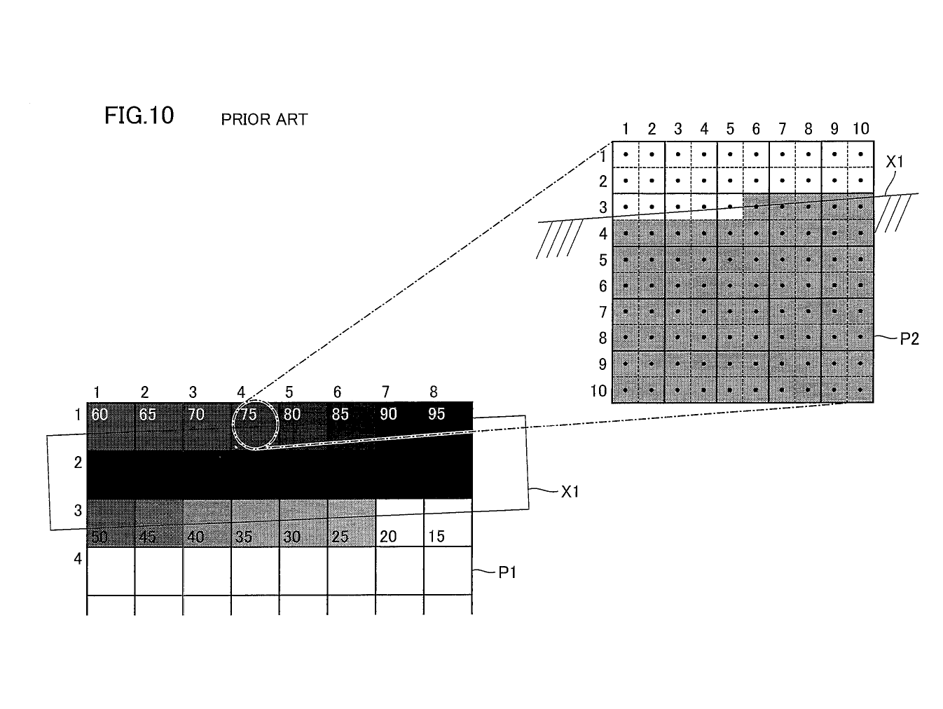

FIG. 9 is a flow chart of a further modification of the process in the flow chart of FIG. 4.

Referring to FIG. 9, in this modification, gradation information creating unit 10 acquires oversampling information in step SA10, acquires information specifying a graphic to be displayed on displaying device 300 in step SA20, and acquires data representing a basic portion of the graphic in step SA30. Thereafter, the process proceeds to step SA44.

In step SA44, gradation information creating unit 10 divides a graphic that is being processed into blocks for each angle of outline data or a skeleton portion, and then the process proceeds to step SA45.

Note that such block dividing is achieved, for example, by dividing a graphic for every stroke in the skeleton data described with reference to FIG. 3B.

In step SA45, gradation information creating unit 10 performs an oversampling process for each block resulting from dividing in step SA44, and the process proceeds to step SA46. In this modification, oversampling information acquired in step SA10 includes information that specifies the number of sub-pixels corresponding to each pixel, and the number of sampling and a sampling position in each sub-pixel in a oversampling process, for example, by using the angle of outline data and a skeleton portion. In step SA45, the oversampling process is performed for each block based on oversampling information in accordance with the slope of the skeleton portion.

In step SA46, gradation information creating unit 10 generates gradation data for each block based on the result of the oversampling process in step SA45. In step SA52, the gradation data is combined to generate a gradation value of the entire graphic, and then the gradation data generation process ends.

According to the present embodiment, gradation data is generated by extracting oversampling information (including information that specifies the number of sampling of each pixel and a sampling position of coloring in a sub-pixel) from a storing unit and performing an oversampling process based on the oversampling information. That is, according to the present invention, gradation data is generated using an oversampling mode.

Thus, processing time can therefore be shortened more than with pulse-surface-area modulation when gradation data is generated.

Although the present invention has been described and illustrated in detail, it is clearly understood that the same is by way of illustration and example only and is not to be taken by way of limitation, the scope of the present invention being interpreted by the terms of the appended claims.

What is claimed is:

1. A data creating apparatus for creating image data for displaying a graphic on a displaying device, comprising:
a first storing unit storing information representing a basic portion of said graphic;
a gradation generating unit for generating gradation data of a portion other than the basic portion of said graphic by an oversampling process; and
a second storing unit for storing oversampling information, the oversampling information being information for performing said oversampling process,
wherein said gradation generating unit generates said gradation data based on the oversampling information extracted from said second storing unit.

2. The data creating apparatus according to claim 1, wherein said oversampling information is information specifying one of a number of sampling for each pixel or a colored sampling position in a sub-pixel.

3. The data creating apparatus according to claim 2, wherein said gradation generating unit extracts said oversampling information based on an index on said graphic.

4. The data creating apparatus according to claim 3, further comprising a block dividing unit for dividing said graphic into blocks for each slope of the basic portion of the graphic based on the information representing the basic portion of said graphic; and
wherein the index on said graphic is a slope of each block of said graphic.

5. The data creating apparatus according to claim 1, wherein said gradation generating unit determines presence of coloring of each sub-pixel for each of a plurality of sampling positions in the sub-pixel, and generates gradation data of each pixel by calculating an average value of a plurality of gradation values for each pixel acquired by determining the presence of coloring at each sampling position.

6. The data creating apparatus according to claim 1, wherein said gradation generating unit determines presence of coloring of each sub-pixel for each of different sampling positions in the sub-pixel, and generates gradation data of each pixel by adding up a plurality of gradation values for each pixel acquired by determining the presence of coloring at each sampling position after assigning weights different from one another to the plurality of gradation values.

7. A drawing apparatus for causing said displaying device to display said graphic based on the image data created by the data creating apparatus according to claim 1, the drawing apparatus comprising:
a data mixing unit for generating data for displaying by mixing display data of a graphic display color and display data of a background display color based on said gradation data; and
a sending unit for sending the data for displaying generated by said data mixing unit to said displaying device.

8. A method of controlling a data creating apparatus for creating image data for displaying a graphic on a displaying device, the data creating apparatus including a first and second storing units, the method comprising the steps of:
causing said first storing unit to store information representing a basic portion of said graphic;
causing said second storing unit to store oversampling information, the oversampling information being information for performing an oversampling process;
extracting the oversampling information from said second storing unit; and
generating gradation data of a portion other than the basic portion of said graphic based on said extracted oversampling information by the oversampling process.

9. A method of controlling a drawing apparatus for causing said graphic to be displayed on said displaying device by sending the image data created by a data creating method according to claim 8 to said displaying device, the method comprising the steps of:
generating data for displaying by mixing display data of a graphic display color and display data of a background display color based on said gradation data; and
sending said data for displaying to said displaying device.

10. A recording medium having recorded thereon a program for creating data for creating image data for displaying a graphic on a displaying device, said program causing a computer to execute the steps of:
causing a first storing unit to store information representing a basic portion of said graphic;
causing a second storing unit to store oversampling information, the oversampling information being information for performing an oversampling process;
extracting the oversampling information from said second storing unit; and
generating gradation data of a portion other than the basic portion of said graphic based on said extracted oversampling information by the oversampling process.

11. A recording medium having recorded thereon a program for drawing for causing said graphic to be displayed on said displaying device by sending the image data created by the program for creating data according to claim 10 to said displaying device, said program for drawing causing the computer to execute the steps of:
generating data for displaying by mixing display data of a graphic display color and display data of a background display color based on said gradation data; and
sending said data for displaying to said displaying device.
